(19) United States
(12) Patent Application Publication
(10) Pub. No.: US 2011/0102305 A1
(43) Pub. Date: May 5, 2011

(54) LIGHT-EMITTING DEVICE

(75) Inventors: Masahiro Tamura, Mobara-shi (JP); Akiharu Takabayashi, Atsugi-shi (JP); Kouji Ikeda, Chiba-shi (JP)

(73) Assignee: CANON KABUSHIKI KAISHA, Tokyo (JP)

(21) Appl. No.: 12/911,378

(22) Filed: Oct. 25, 2010

(30) Foreign Application Priority Data
Oct. 30, 2009 (JP) 2009-250832

(51) Int. Cl. G09G 3/30

(52) U.S. Cl. 345/80

(57) ABSTRACT

A light-emitting device includes a plurality of pixels including an organic electroluminescent element, a drive transistor driving the organic electroluminescent element, and a hold capacitor holding a control signal for controlling the drive transistor, the organic electroluminescent element being electrically connected to one of a source electrode and a drain electrode of the drive transistor. The hold capacitor includes a metal layer, an insulating layer, and a semiconductor layer in this order. The semiconductor layer receives light emitted from the organic electroluminescent element. One of the metal layer and the semiconductor layer of the hold capacitor is electrically connected to a gate electrode of the drive transistor, and the other of the metal layer and the semiconductor layer of the hold capacitor is specified at a fixed potential.

### BACKGROUND OF THE INVENTION

1. Field of the Invention

The present invention relates to light-emitting devices having a plurality of organic electroluminescent elements, and in particular, to a light-emitting device in which variations in brightness are suppressed.

2. Description of the Related Art

Light-emitting devices having a plurality of organic electroluminescent elements attract a considerable attention as selfluminous devices that hold promise for low profile and low power consumption. The organic electroluminescent element has an organic compound layer between an anode and a cathode and emits light using energy generated when electrons and holes injected into the organic compound layer from the cathode and the anode, respectively, are recombined.

It is known that the organic electroluminescent element exhibits degradation, such as decreasing in brightness, with a lapse of driving time to increase the driving voltage. Since the degradation differs from one organic electroluminescent element to another, variations in brightness occur in a light-emitting device having a plurality of organic electroluminescent elements. The variations in brightness are a phenomenon in which brightness differs for the same input signal among organic electroluminescent elements to cause differences in visual brightness. To correct the variations in brightness, Japanese Patent Laid-Open No. 2006-30317 proposes an organic electroluminescent display in which a photosensor is provided in each pixel, and the brightness is compensated for each pixel depending on the emission quantity of each organic electroluminescent element.

### SUMMARY OF THE INVENTION

The present invention suppresses variations in brightness.

According to an aspect of the present invention, there is provided a light-emitting device including a plurality of pixels including an organic electroluminescent element, a drive transistor driving the organic electroluminescent element, and a hold capacitor holding a control signal for controlling the drive transistor, the organic electroluminescent element being electrically connected to one of a source electrode and a drain electrode of the drive transistor. The hold capacitor includes a metal layer, an insulating layer, and a semiconductor layer in this order. The semiconductor layer receives light emitted from the organic electroluminescent element. One of the metal layer and the semiconductor layer of the hold capacitor is electrically connected to a gate electrode of the drive transistor, and the other of the metal layer and the semiconductor layer of the hold capacitor is specified at a fixed potential.

With the light-emitting device according to the aspect of the present invention, variations in brightness can be suppressed.

Further features of the present invention will become apparent from the following description of exemplary embodiments with reference to the attached drawings.

### BRIEF DESCRIPTION OF THE DRAWINGS

FIG. 1A is a schematic diagram illustrating a light-emitting device according to a first embodiment of the present invention.

FIG. 1B is a schematic plan view of a pixel of the light-emitting device according to the first embodiment.

FIG. 1C is a diagram of a circuit in the pixel according to the first embodiment.

FIG. 2A is a diagram of a hold capacitor used in the light-emitting device according to the first embodiment, to which a desired voltage is applied in advance.

FIG. 2B is a graph showing the measurements of the voltage across the hold capacitor according to the first embodiment.

FIG. 3 is a diagram illustrating an operation in which variations in brightness are compensated.

FIG. 4 is a partial cross-sectional view of the light-emitting device according to the first embodiment.

FIG. 5A is a diagram of the circuit of a light-emitting device according to a second embodiment of the present invention.

FIG. 5B is a graph showing the relationship between the sensitivity of the hold capacitor and the signal voltage.

FIG. 6 is a diagram of the circuit of a light-emitting device according to another embodiment of the present invention.

### DESCRIPTION OF THE EMBODIMENTS

### First Embodiment

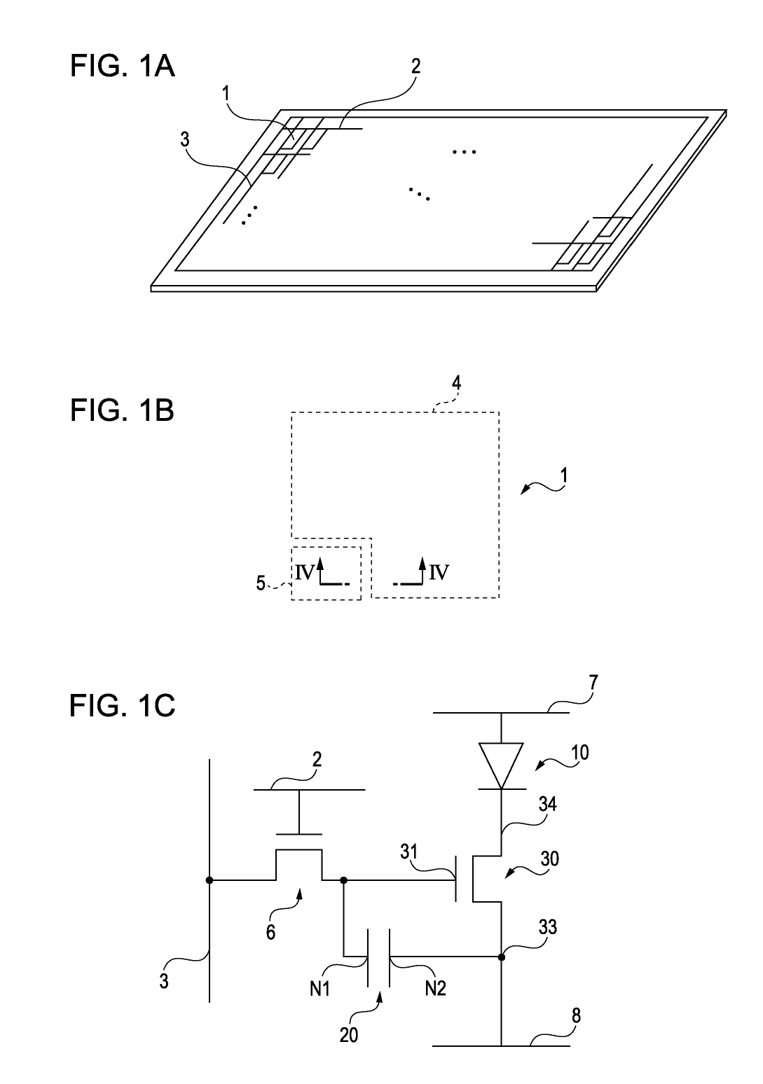

An embodiment of the present invention will be described with reference to the drawings. FIG. 1A is a schematic perspective view of a light-emitting device having a plurality of pixels. Pixels 1 are disposed in the vicinity of intersections of signal lines 3 for sending control signals to the pixels 1 and select lines 2 for selecting pixels 1 to which the control signals are to be sent. FIG. 1B is a schematic plan view of the pixel 1 of the light-emitting device according to the embodiment of the present invention. The pixel 1 is constituted by an emission region 4 in which an organic electroluminescent element is formed and a nonemission region 5 in which a circuit for driving the organic electroluminescent element is formed. The emission region 4 of the pixel 1 includes the organic electroluminescent element and a hold capacitor for holding a control signal. The nonemission region 5 of the pixel 1 includes a drive transistor for driving the organic electroluminescent element. The control signal is a signal that controls the drive transistor. A current responding to the signal is sent to the organic electroluminescent element by the drive transistor. The emission intensity of the organic electroluminescent element is determined by the control signal. The control signal is sent to the pixel 1 at a potential responding to the signal (hereinafter referred to as a signal potential).

The hold capacitor used in the embodiment of the present invention includes a metal layer, an insulating layer, and a semiconductor layer in this order. The semiconductor layer is provided at a position that receives light emitted from the organic electroluminescent element and has the function of photoelectric conversion, such as an amorphous silicon layer.

FIG. 1C is a diagram of a circuit in the pixel 1 of this embodiment. In FIG. 1C, reference numeral 6 denotes a select transistor. The gate electrode of the select transistor 6 is connected to the select line 2. The drain electrode of the select transistor 6 is connected to the signal line 3. The source electrode of the select transistor 6 is connected to the gate electrode of a drive transistor 30. Reference numeral 7 denotes a feeder line for supplying a drive current to the organic electroluminescent element 10. The feeder line 7, the organic electroluminescent element 10, the drive transistor 30, and a GND line 8 are electrically connected in series. There may be a transistor for controlling the emission period electrically connected in series between the organic electroluminescent element 10 and the drive transistor 30. One terminal N1 of the hold capacitor 20 is electrically connected to a gate electrode 31 of the drive transistor 30, and the other terminal N2 of the hold capacitor 20 is electrically connected to a source electrode 33 of the drive transistor 30 and to the GND line 8. The terminal N2 of the hold capacitor 20 is specified at a fixed potential by the GND line 8. This configuration allows variations in brightness to be compensated with the configuration in the pixel 1, as described below.

When the light-emitting device is to be driven, first, a binary potential that turns on or off the select transistor 6 is applied in sequence to the select line 2. The pixel 1 in which a potential that turns on the select transistor 6 is applied to the select line 2 is given a control signal through the signal line 3, and the control signal is held in the hold capacitor 20. Specifically, a charge quantity corresponding to a potential difference between the signal potential and a potential applied to the GND line 8 (hereinafter referred to as a signal voltage) is held in the hold capacitor 20. Even if a potential that turns off the select transistor 6 is thereafter applied to the select line 2 during the emission period of the organic electroluminescent element 10, the charge quantity corresponding to the signal voltage is kept held in the hold capacitor 20. Then, a drive current corresponding to the potential difference between the gate and source of the drive transistor 30, that is, corresponding to the control signal held in the hold capacitor 20, is supplied to the organic electroluminescent element 10 through the feeder line 7, so that the organic electroluminescent element 10 emits light at an emission intensity responding to the control signal.

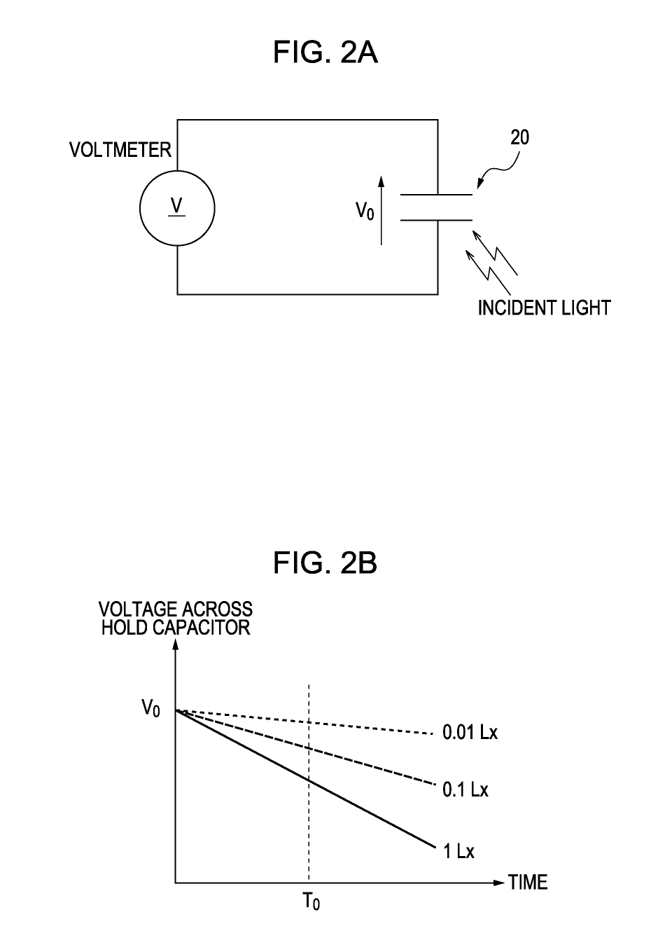

Next, FIGS. 2A and 2B illustrate an operation in which the hold capacitor 20 according to the embodiment of the present invention receives light, so that the voltage across the hold capacitor 20 decreases. Referring to FIG. 2A, a charge quantity corresponding to a desired voltage V₀ is held in the hold capacitor 20 in advance. Lights with different intensities (1 Lx, 0.1 Lx, and 0.01 Lx) are applied to the hold capacitor 20, and the voltages across the hold capacitor 20 are measured by a voltmeter. The measurements are shown in FIG. 2B. This graph shows that the hold capacitor 20 according to the embodiment of the present invention has the characteristic of decreasing in voltage across the hold capacitor 20 by receiving light. This is because a semiconductor layer 23 in the hold capacitor 20 of the embodiment of the present invention generates electric charges (electrons and holes) by receiving light. The reason that the voltage across the hold capacitor 20 is set at V₀ in advance is to bring about a state in which an electric field is generated between both terminals of the hold capacitor 20. With this electric field, one of the generated electric charges is removed from one end of the hold capacitor 20, and the other electric charge is stored in the insulating-layer-side interface of the semiconductor layer to change the portion constituting the capacitor. More specifically, the capacitor that was formed between the metal layer and the interface of the semiconductor layer opposite to the metal layer is formed between the metal layer and the metal-layer-side interface of the semiconductor layer. This results in an increase in the capacity of the hold capacitor 20. However, since the total sum of the charge quantity does not change, the voltage across the hold capacitor 20 decreases. The quantity of electric charges generated in the semiconductor layer differs depending on the intensity of incident light. Accordingly, as shown in FIG. 2B, the larger the intensity of incident light, the more the quantity of electric charges held in the hold capacitor 20 after a lapse of a desired time t₀ decreases, so that the voltage across the hold capacitor 20 is decreased.

Next, an operation in which variations in brightness in the pixel 1 are suppressed in the light-emitting device in which this action is applied according to the embodiment of the present invention will be described. In the circuit diagram of FIG. 1C, when the hold capacitor 20 receives the light from the organic electroluminescent element 10, the signal voltage, that is, the voltage across the hold capacitor 20, decreases because the capacity of the hold capacitor 20 increases, while the held charge quantity does not change. Since the terminal N2 of the hold capacitor 20 is electrically connected to the source electrode 33 of the drive transistor 30 and to the GND line 8, and its potential is fixed to a potential lower than the signal potential, the potential of the terminal N1 of the hold capacitor 20 (the potential of the gate electrode 31 of the drive transistor 30) falls. Therefore, the potential difference between the gate and source of the drive transistor 30 is decreased, so that a drive current applied to the organic electroluminescent element 10 becomes smaller than the initial drive current during the emission period (for example, 1/60 sec.) of one frame.

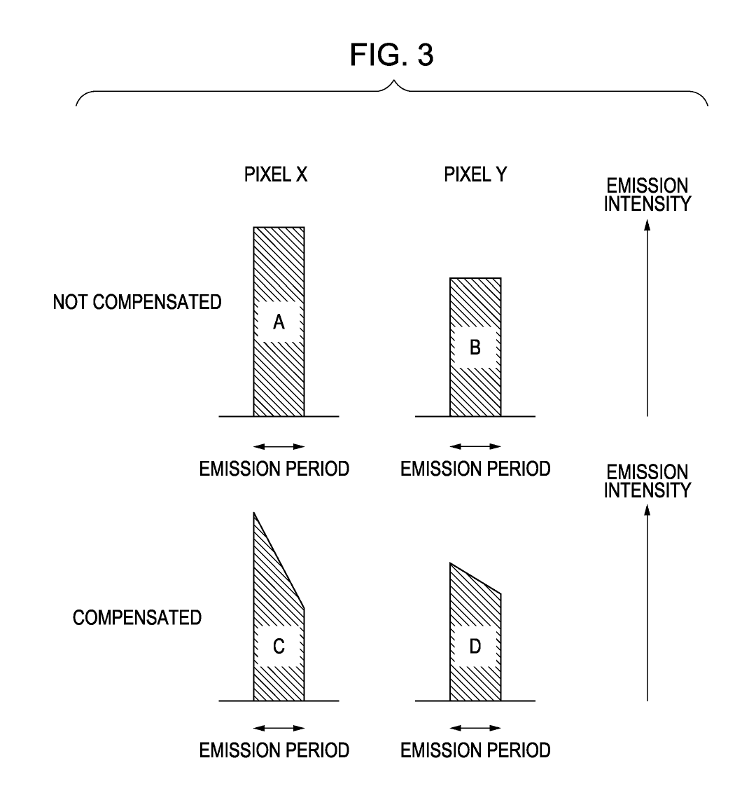

FIG. 3 is a diagram showing a comparison for a pixel X in which the degradation level of its organic electroluminescent element deteriorates is low and a pixel Y in which the degradation level of its organic electroluminescent element is high between a case in which the hold capacitor 20 of the embodiment of the present invention is used in FIG. 1C (compensated) and a case in which a conventional hold capacitor is used instead of the hold capacitor 20 in FIG. 1C (not compensated). The hold capacitors of the pixel X and the pixel Y hold the same charge quantity corresponding to the same signal voltage. The conventional hold capacitor has no semiconductor layer. If the organic electroluminescent element degrades, the emission intensity changes even if the hold capacitor holds the same charge quantity. Human eyes recognize the integrated value of emission intensity during the emission period of one frame, that is, the area (A, B, C, or D) indicated by the diagonally shaded portion in FIG. 3, as a brightness level. Accordingly, with the conventional hold capacitor, differences from the initial emission intensity during the emission period are integrated, and the difference between area A of the pixel X and area B of the pixel Y is recognized as a brightness difference by human eyes.

In contrast, with the hold capacitor 20 according to the embodiment of the present invention, the emission of the pixels X and Y becomes uneven during the emission period. That is, as shown in FIG. 2B, the organic electroluminescent element begins to emit light, so that the voltage across the hold capacitor 20 that has received the light emitted from the organic electroluminescent element decreases depending on the emission intensity of the organic electroluminescent element in the pixel. In the pixel Y, the decrease of signal voltage across the hold capacitor 20 is smaller than that of the pixel X. Therefore, a difference in emission intensity during the emission period between the pixel X and the pixel Y using the hold capacitor 20 according to the embodiment of the present invention is smaller than a difference in mission intensity during the emission period between a pixel with a high level of degradation and a pixel with a low level of degradation using the conventional hold capacitor. In other words, the difference between area C and area D is smaller than the difference between area A and area B, which makes it difficult for human eyes to recognize the difference as the brightness difference between the pixel X and the pixel Y. Accordingly, the circuit in the pixel equipped with the hold capacitor 20 according to the embodiment of the present invention can reduce variations in brightness. With an emission period of about 1/60 second, changes in emission intensity during the emission period have no problem because they cannot be recognized.

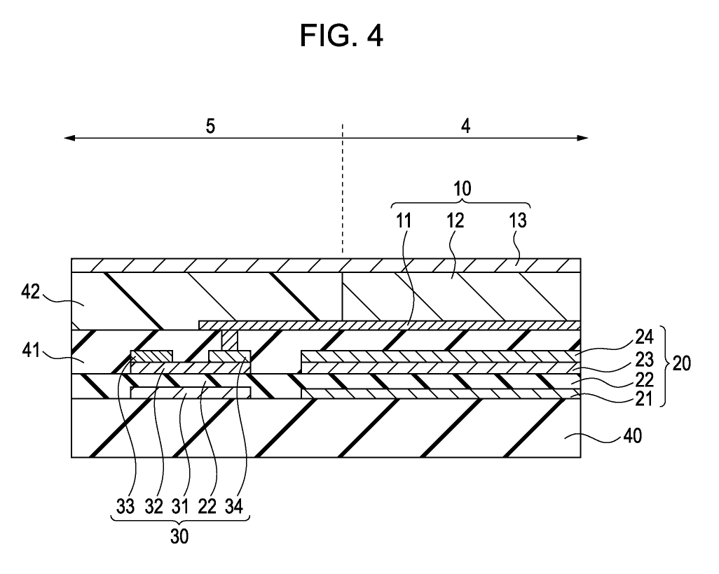

FIG. 4 is a cross-sectional view taken along line IV-IV in FIG. 1B. In the emission region 4, the hold capacitor 20 is disposed on a substrate 40, and the organic electroluminescent element 10 is disposed thereon. With this configuration, light that has passed through a second electrode 11 of the organic electroluminescent element 10 is introduced into the hold capacitor 20.

The organic electroluminescent element 10 has a configuration in which the second electrode 11, an organic compound layer 12, and a first electrode 13 are provided on the insulative substrate 40 made of, such as glass, quartz, and ceramic, in order from the substrate 40, and is disposed in the emission region 4. The organic electroluminescent element 10 is stacked on the hold capacitor 20, with an insulating layer 41 made of SiOx, SiNx, or a film stack thereof therebetween. Emission of the organic electroluminescent element 10 uses energy when electrons or holes are injected from the second electrode 11 and the first electrode 13, respectively, into the organic compound layer 12 and are recombined in the organic compound layer 12. In this embodiment, a so-called top-emission type light-emitting device in which light from the organic electroluminescent element is extracted from the opposite side of the substrate 40 (from the first electrode 13 side) will be described.

The second electrode 11 may be a metal layer made of simple metal, such as Al, Cr, Ag, and an alloy thereof. The second electrode 11 has the function of reflecting the light from the organic electroluminescent element 10. The second electrode 11 needs to be used at a thickness between 30 nm and 200 nm, more preferably, between 30 nm and 50 nm to allow part (between 0.01% and 10%) of the light from the organic electroluminescent element to pass through the hold capacitor 20, to be described later. Furthermore, a metal oxide conductive layer with high light transmittance, such as a compound layer made of indium oxide and tin oxide and a compound layer made of indium oxide and zinc oxide, may be formed on the metal layer. In the present invention, the high light transmittance means that the transmittance at the peak wavelength of the spectrum of light extracted from the organic electroluminescent element is between 50% and 100%.

The organic compound layer 12 has at least a light-emitting layer and has a charge transport layer, such as a hole transport layer and an electron transport layer, as necessary. The layer that constitutes the organic compound layer can be formed of a known material using a known method, such as a resistance heating evaporation method and a spin coating method.

The first electrode 13 may be the above-described metal layer with a thickness between 5 nm and 20 nm or a single layer of the above-described metal oxide conductive layer with high light transmittance to allow 60% or more of the light generated in the organic electroluminescent element 10 to pass therethrough. The first electrode 13 may also adopt a stacked structure thereof.

Reference numeral 42 denotes an insulating layer for preventing shorting of the second electrode 11 and the first electrode 13 and may be formed of acryl resin or polyimide resin with a thickness between 1 μm and 3 μm.

The hold capacitor 20 adopts a configuration in which a metal layer 21, an insulating layer 22, the semiconductor layer 23, and a conductive layer 24 are disposed on the substrate 40 in order from the substrate 40. The semiconductor layer 23 is formed of a photoelectric conversion layer that generates electric charge by receiving light. In this embodiment, the hold capacitor 20 is disposed between the second electrode 11 of the organic electroluminescent element 10 and the substrate 40. The light emitted from the organic electroluminescent element 10 passes through the second electrode 11 and is received by the semiconductor layer 23 of the hold capacitor 20. By receiving the light from the organic electroluminescent element 10 with the semiconductor layer 23, the hold capacitor 20 can be used also as a photo detector and as compensating means for compensating variations in brightness.

To allow the light to be received by the semiconductor layer 23 more efficiently, the area of the hold capacitor 20 in the direction of the plane of the substrate 40 is preferably larger than the emission area of the organic electroluminescent element 10 in the emission region 4. The emission area is the area of the emission region 4 and also the area of a region in the direction of the plane of the substrate 40 in which the second electrode 11, the organic compound layer 12, and the first electrode 13 overlap in the vertical direction on the substrate 40, and the insulating layer 42 is not disposed. In FIG. 4, the organic electroluminescent element 10 is formed on the hold capacitor 20. This is because, since the hold capacitor also serves as a photo detector, unlike a photo detector such as a general phototransistor, the flatness of the top of the photo detector is sufficiently ensured. Therefore, there is no need to provide a flattening resin layer with a thickness of order of microns between the hold capacitor 20 (photo detector) and the organic electroluminescent element 10, thus allowing the light from the organic electroluminescent element 10 to be efficiently absorbed in the semiconductor layer 23 of the hold capacitor 20.

The semiconductor layer 23 serving as a photoelectric conversion layer may be either of N-type and P-type semiconductor layers. Specifically, an amorphous silicon layer or a microcrystalline silicon layer may be used; the amorphous silicon layer is preferable in view of photoelectric conversion efficiency. The semiconductor layer 23 may adopt a configuration in which an amorphous silicon layer and an N-type or P-type amorphous silicon layer in which impurities are doped. The thickness of the semiconductor layer 23 is preferably between 50 nm and 300 nm. The semiconductor layer 23 formed of the N-type amorphous silicon layer will be described hereinbelow.

The metal layer 21 can be made of Mo, Ti, W, Ni, Ta, Cu, Al, an alloy thereof, or a stacked structure thereof. The thickness is preferably between 5 nm and 300 nm.

The insulating layers 22 and 41 can be made of SiOx, SiNx, or a film stack thereof. The thickness is preferably between 100 nm and 500 nm. The capacity of the hold capacitor 20 can be changed depending on the thickness of the insulating layer 22.

The conductive layer 24 can be made of the same material as that of the metal layer 21. However, since the light from the organic electroluminescent element 10 needs to reach the semiconductor layer 23 through the conductive layer 24, the conductive layer 24 preferably has a thickness between 5 nm and 200 nm so as to provide a transmittance of 1% or higher. The conductive layer 24 can be a metal oxide conductive layer with high light transmittance, such as a compound layer made of indium oxide and tin oxide and a compound layer made of indium oxide and zinc oxide.

The terminal N1 of the hold capacitor 20 in FIG. 1C, which electrically connects to the gate electrode 31 of the drive transistor 30, corresponds to the conductive layer 24 in FIG. 4. The semiconductor layer 23 is electrically connected to the gate electrode 31 of the drive transistor 30 via the conductive layer 24. The other terminal N2 of the hold capacitor 20 corresponds to the metal layer 21 in FIG. 4.

The drive transistor 30 includes the gate electrode 31, the insulating layer 22, a semiconductor layer 32, the source electrode 33, and a drain electrode 34 and is formed in the nonemission region 5. The drain electrode 34 is electrically connected to the second electrode 11 of the organic electroluminescent element 10. The semiconductor layer 32 is made of amorphous silicon. The region of the semiconductor layer 32 on which the source electrode 33 and the drain electrode 34 are formed is doped with N-type impurities. With this configuration, the drive transistor 30 serves as an N-type transistor. The gate electrode 31, the source electrode 33, and the drain electrode 34 can be made of the same material as that of the metal layer 21 of the hold capacitor 20.

In FIG. 4, although the insulating layer 22 of the drive transistor 30 is integrated with the insulating layer 22 of the hold capacitor 20, it is not limited thereto. In other words, the insulating layer 22 of the drive transistor 30 and the insulating layer 22 of the hold capacitor 20 may be made of different materials or with different thicknesses.

The semiconductor layer 32 may be made of either the same material as that of the semiconductor layer 23 of the hold capacitor 20 or a different material therefrom.

In this embodiment, although the organic electroluminescent element 10 is connected to the drain electrode 34 of the drive transistor 30, the organic electroluminescent element 10 may be connected to the source electrode 33 of the drive transistor 30.

The pixel 1 may have an auxiliary capacitor (not shown) connected to the gate electrode 31 of the drive transistor 30, in addition to the hold capacitor 20.

### Second Embodiment

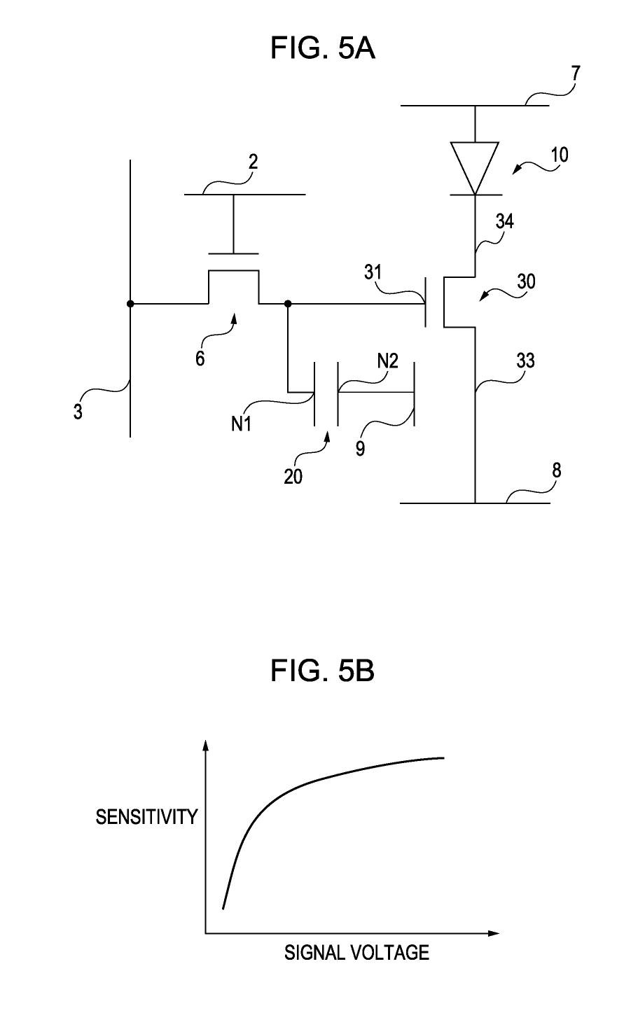

FIG. 5A is a diagram of a circuit in a pixel of a second embodiment. The second embodiment differs from the first embodiment in that the terminal N2 different from the terminal N1 that is electrically connected to the gate electrode 31 of the drive transistor 30 of the hold capacitor 20 is connected a potential line 9 that supplies a fixed potential. The terminal N2 of the hold capacitor 20 is specified at a fixed potential by this potential line 9.

The terminal N1 of the hold capacitor 20 in FIG. 5A, which is electrically connected to the gate electrode 31 of the drive transistor 30, corresponds to the metal layer 21, and the other terminal N2 of the hold capacitor 20 corresponds to the semiconductor layer 23.

In the first embodiment, the signal voltage across the hold capacitor 20 is the voltage across the gate and source of the drive transistor 30. Therefore, if the emission intensity of the organic electroluminescent element is low, the signal voltage across the hold capacitor 20 is small, so that the light sensitivity of the hold capacitor 20 is small as shown in FIG. 5B. In contrast, in the second embodiment, a fixed potential lower than the signal potential and lower than that of the GND line 8 is applied to the potential line 9. Therefore, the potential of the terminal N2 of the hold capacitor 20 is lower than that of the first embodiment. Since the emission intensity of the organic electroluminescent element 10 is the voltage across the gate and source of the drive transistor 30, the gate electrode 31 of the drive transistor 30 of the hold capacitor 20 needs to have the same potential as that of the first embodiment to make the organic electroluminescent element 10 emit light at the same emission intensity as in the first embodiment. Therefore, the signal voltage across the hold capacitor 20 is higher than that of the first embodiment, which enhances the light sensitivity of the hold capacitor 20, as shown in FIG. 5B, thus allowing the hold capacitor 20 to be used in a region with more stable sensitivity. This can more accurately suppress the variations in brightness of the pixel.

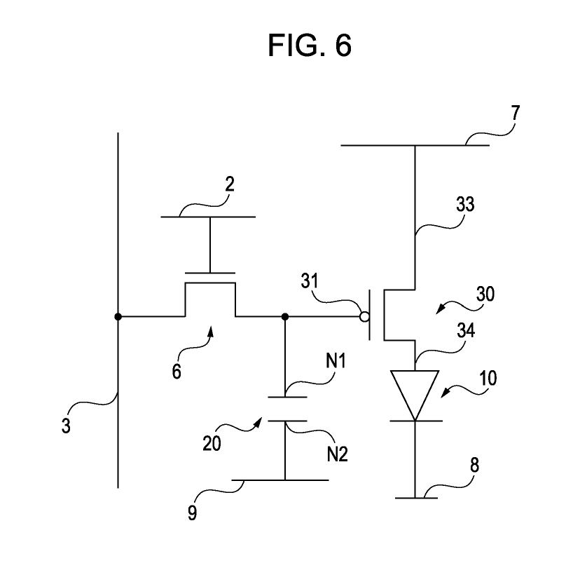

Although the first embodiment and the second embodiment have been described using the N-type drive transistor 30, a P-type drive transistor can also be used. For example, to form the circuit configuration shown in FIG. 6, the semiconductor layer 32 of the drive transistor 30 is formed of a microcrystalline silicon layer, and the semiconductor layer 23 of the hold capacitor 20 and the gate electrode 31 of the drive transistor 30 is electrically connected in FIG. 4. With this configuration, the semiconductor layer 23 that is the second terminal N2 of the hold capacitor 20 is electrically connected to the potential line 9 that applies a fixed potential, and the fixed potential is set higher than the signal potential.

Alternatively, if the drive transistor is of N type, and a P-type semiconductor layer is used as the semiconductor layer of the hold capacitor, the metal layer of the hold capacitor is electrically connected to the gate electrode of the drive transistor, and the semiconductor layer of the hold capacitor is set at a fixed potential lower than the signal potential. Alternatively, if the drive transistor is of P-type, and an N-type semiconductor layer is used as the semiconductor layer of the hold capacitor, the metal layer of the hold capacitor is electrically connected to the gate electrode of the drive transistor, and the semiconductor layer of the hold capacitor is set at a fixed potential higher than the signal potential.

To enhance the effect of compensation, there is a method of increasing the capacity of the hold capacitor in addition to increasing the voltage across the hold capacitor, as described above. Specifically, there are a method of increasing the area of the hold capacitor in the direction of the plane of the substrate and a method of decreasing the thickness of the insulating layer of the hold capacitor. Alternatively, there are a method of decreasing the thickness of the insulating layer between the hold capacitor and the organic electroluminescent element and a method of decreasing the thickness of the second electrode of the organic electroluminescent element.

The light-emitting devices according to the embodiments of the present invention can be applied to various uses, such as a back light for a display. Furthermore, they can also be applied to displays of television systems, personal computers, digital cameras, and mobile phones.

As shown in FIG. 1A, although the light-emitting device according to the first embodiment of the present invention is configured such that pixels are arrayed in two dimensions, the present invention can also be applied to a light-emitting device in which pixels are arrayed in one dimension, which can also be used as the light source of an exposure apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-250832 filed Oct. 30, 2009, which is hereby incorporated by reference herein in its entirety.

What is claimed is:

1. A light-emitting device comprising:
a plurality of pixels including an organic electroluminescent element, a drive transistor driving the organic electroluminescent element, and a hold capacitor holding a control signal for controlling the drive transistor, the organic electroluminescent element being electrically connected to one of a source electrode and a drain electrode of the drive transistor, wherein
the hold capacitor includes a metal layer, an insulating layer, and a semiconductor layer in this order;
the semiconductor layer receives light emitted from the organic electroluminescent element;
one of the metal layer and the semiconductor layer of the hold capacitor is electrically connected to a gate electrode of the drive transistor, and the other is specified at a fixed potential.

2. The light-emitting device according to claim 1, further comprising a substrate, wherein
the hold capacitor is disposed between the substrate and the organic electroluminescent element; and
the area of the hold capacitor in the direction of the plane of the substrate is larger than the emission area of the organic electroluminescent element.

3. The light-emitting device according to claim 1, wherein
the other of the metal layer and the semiconductor layer of the hold capacitor is connected to one of the source electrode and the drain electrode of the drive transistor.
